(19) United States
(12) Patent Application Publication
(10) Pub. No.: US 2016/0238569 A1
(43) Pub. Date: Aug. 18, 2016

(54) DETECTING METHOD FOR IMPROVING RESOLUTION OF AREA ARRAY PROBE

(71) Applicant: NDT TECHNOLOGY (SHANGHAI) CO., LTD, Shanghai (CN)

(72) Inventor: Rui ZHANG, Shanghai (CN)

(73) Assignee: NDT Technology (Shanghai) Co., Ltd.

(21) Appl. No.: 15/026,568

(22) PCT Filed: Mar. 20, 2015
(86) PCT No.: PCT/CN2015/074693

§ 371 Date: Mar. 31, 2016

(30) Foreign Application Priority Data
Jun. 3, 2014 (CN) 201410243103.0

(51) Int. Cl. G01N 29/44; G01N 29/04

(52) U.S. Cl. CPC G01N 29/44; G01N 29/04; G01N 2291/0289; G01N 2291/023

(57) ABSTRACT

The invention provides a detecting method for improving a resolution ratio of an area array probe. The detecting method comprises the following steps: firstly, an ultrasonic area array probe is provided with N wafers that are arranged in the form of an area array; secondly, controlling a wafer a to send m impulse waves toward a to-be-detected workpiece through a chip; thirdly, successively respectively receiving the impulse waves reflected by the to-be-detected workpiece through a wafer and adjacent (m−1) wafers of the wafer; fourthly, when the N chips all send the m impulse waves, and fully receiving the impulse waves reflected by the to-be-detected workpiece; fifthly, repeating the previous four steps until flaw detection is finished; and lastly, obtaining a defect diagram of the to-be-detected workpiece by analytical processing of the impulse waves received by a main engine, displaying through a displayer arranged on the main engine.

### FIELD OF THE INVENTION

The present invention relates to the technical field of ultrasonic defect detection and in particular relates to a detection method capable of improving a resolution of an area array probe.

### BACKGROUND OF THE INVENTION

Ultrasonic defect detection technique is an important way in non-destructive inspection of metal test pieces and parts. When ultrasonic waves are propagated in a detected material, the acoustic characteristics and the change of the internal structure of the material produce certain influence on the propagation of the ultrasonic waves, and a technique of knowing the properties and the structural change of the material by detecting the influenced degree and condition of the ultrasonic waves is called ultrasonic detection. Ultrasonic defect detection is a method of detecting defective parts by using the features of the ultrasonic waves that the ultrasonic waves are capable of penetrating into metals and reflected at the edges of sections when going from one section into another section.

A wafer is the most core component in an ultrasonic defect detector; the wafer emits impulse waves to a workpiece to be detected and the impulse waves reflected by the workpiece to be detected are processed and analyzed to obtain a defect graph of the workpiece to be detected; in the prior art, taking a probe having a diameter of 10 mm as an example, 52 wafers are required in an 8*8 wafer array, and only when a space between the wafers reaches 1.25 mm, the 10 mm diameter range of the probe can be covered; additionally, during working, each wafer emits and receives impulse waves independently, leading to that a resolution of the defect detector is less than 1.25 mm when the space between the wafers is 1.25 mm and thus accurate defect defection on parts cannot be realized; if the resolution is improved by increasing the number of the wafers, the cost of the defect detector can be certainly increased, and the power consumption can also be increased.

### SUMMARY OF THE INVENTION

To solve the above problem, the invention provides a detection method capable of improving a defect detection resolution of a detector without increasing the number of wafers. A technical solution of a detection method capable of improving a resolution of an area array provided by the present invention is as follows:

The invention provides a detection method capable of improving a resolution of an area array probe, comprising the following steps:

step 1, an ultrasonic area array probe is provided with N wafers that are arranged in the form of an area array, wherein N represents the number of the wafers;

step 2, a chip controls a wafer a to emit impulse waves to a workpiece to be detected for m times, wherein a represents the a^{th} wafer and m represents the times of emitting impulses;

step 3, the impulse waves reflected by the workpiece to be detected are successively received by the wafer a and (m−1) wafers adjacent to the wafer a, respectively;

step 4, all the N wafers emit impulse waves for m times successively, and the impulse waves reflected by the workpiece to be detected are completely received;

step 5, the process of the step 1 to the step 4 is repeated until defect detection is finished; and

step 6, a host analytically processes the received impulse waves to obtain a defect graph of the workpiece to be detected, and the defect graph is displayed through a display of the host.

As a further feature, the step 2 further comprises the following steps:

a first step, a timer presets a fixed time interval, and the timer is connected with the chip;

a second step, the chip controls a first switch connected with an impulse wave emitting circuit, such that the impulse wave emitting circuit is connected with a first wafer, and the first wafer emits the impulse wave to the workpiece to be detected for the first time;

a third step, after the time interval elapses, the timer sends a time signal to the chip;

a fourth step, after the time signal is received, the chip controls the first wafer to emit the impulse wave to the workpiece to be detected for the second time, and the first wafer does not finish work until the first wafer emits the impulse wave to the workpiece to be detected for the m^{th} time, and at this moment, the count of the counter connected with the chip is 1;

a fifth step, after the time interval elapses, the timer sends a time signal to the chip;

a sixth step, after the time signal is received, the chip controls the impulse wave emitting circuit to be connected with a second wafer, and the second wafer emits the impulse wave to the workpiece to be detected for the first time; and the working process of the third step and the fourth step is repeated until the count of the counter is 2; and

a seventh step, the chip controls a third wafer to a wafer N to repeat the working process of the fifth step and the sixth step until the count of the counter is N.

As a further feature, the step 3 further comprises the following steps:

a first step, the chip controls a second switch connected with an impulse wave receiving circuit such that the impulse wave receiving circuit is connected with the first wafer, and the first wafer receives the impulse waves reflected by the workpiece to be detected;

a second step, after the first wafer finishes receiving, the chip controls the second switch connected with the impulse wave receiving circuit such that a wafer b is connected with the impulse wave receiving circuit, and the wafer b receives the impulse waves reflected by the workpiece to be detected, wherein the wafer b represents a wafer transversely adjacent to the first wafer;

a third step, after the wafer b finishes receiving, the chip controls the second switch connected with the impulse wave receiving circuit such that a wafer c is connected with the impulse wave receiving circuit, and the wafer c receives the impulse waves reflected by the workpiece to be detected, wherein the wafer c represents a wafer longitudinally adjacent to the first wafer;

a fourth step, after the wafer c finishes receiving, the chip controls the second switch connected with the impulse wave receiving circuit such that a wafer d is connected with the impulse wave receiving circuit, and the wafer d receives the impulse waves reflected by the workpiece to be detected, wherein the wafer d represents a wafer slantwise adjacent to the first wafer; and

a fifth step, after the first wafer finishes work, the second wafer repeats the process of the first step to the fourth step until the wafer N completes the process of the first step to the fourth step successively.

As a further feature, the chip is a programmable chip.

As a further feature, the N wafers refer to 52 wafers.

As a further feature, m in the step 2 is equal to 4.

The invention, compared with the prior art, has the following advantages and beneficial effects:

1, each wafer in the present invention emits the impulse waves for 4 times, and the impulse waves are received by the wafer itself, the transversely adjacent wafers, the longitudinally adjacent wafers and the slantwise adjacent wafers, respectively; as compared with the case that a wafer independently emits and receives the impulse waves in the prior art, adopted waveform data is increased by 3 times; between every two adjacent wafers for sampling, a mode of one for emitting and the other one for receiving is adopted to realize a quadruple interpolated resolution, and therefore, a sampling resolution of a defect detector is improved; as a result, a resolution of a defect detector employing the detection method of the present invention reaches 4 times that in the prior art and a defect detection result is clearer and more accurate.

2, the defect detector of the present invention involves improvements based on existing equipment, and is simple in structure, low in cost and easy to popularize.

3, the counter is added in the present invention; the probe of the defect detector is provided with N wafers; when the defect detector works, 1 is added to the count of the counter after each wafer emits the impulse waves for m times; when the count of the counter is N, the chip controls the defect detector to start emitting the impulse waves again from the first wafer; and through repeatedly emitting and receiving the impulse waves, the defect shape of the workpiece to be detected obtained by the defect detector is more accurate.

4, the timer is added in the present invention, and the chip controls the time interval of emitting the impulse waves according to the time interval predetermined by the timer.

### BRIEF DESCRIPTION OF THE DRAWINGS

To describe embodiments of the present invention or technical solutions in the prior art more clearly, accompanying drawings for use in descriptions of the embodiments or the prior art will be described simply below; obviously, the accompanying drawings in the descriptions below are merely some embodiments of the present invention, and for those of ordinary skill in the art, other accompanying drawings may also be obtained according to the accompanying drawings without creative labor.

FIG. 1 is a schematic diagram of a connection relation of wafers and a chip in a detection method capable of improving a resolution of an area array probe of the present invention;

FIG. 2 is a schematic diagram of a wafer area array structure in an embodiment of a detection method capable of improving a resolution of an area array probe of the present invention.

### DETAILED DESCRIPTION OF THE EMBODIMENTS

The technical solutions in the embodiments of the present invention will be described clearly and completely below in conjunction with the accompanying drawings in the embodiments of the present invention. Obviously, the described embodiments are merely one part of embodiments of the present invention rather than all the embodiments. On the basis of the embodiments in the present invention, all the other embodiments obtained by those of ordinary skill in the art without creative labor fall into the scope of protection of the present invention.

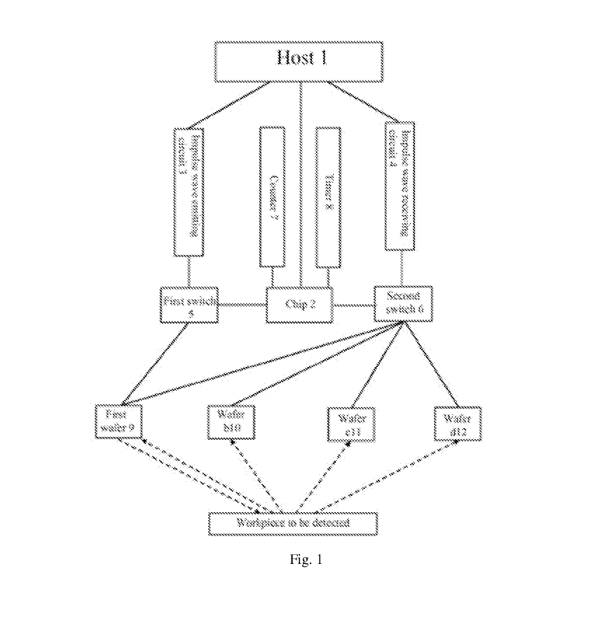

As shown in FIG. 1, the present invention provides a detection method capable of improving a resolution of an area array probe, comprising the following steps:

step 1, an ultrasonic area array probe is provided with N wafers that are arranged in the form of an area array, wherein N represents the number of the wafers;

step 2, a chip 2 controls a wafer a to emit impulse waves to a workpiece to be detected for m times, wherein a represents the a^{th} wafer and m represents the times of emitting impulses;

step 3, the impulse waves reflected by the workpiece to be detected are successively received by the wafer a and (m−1) wafers adjacent to the wafer a, respectively;

step 4, all the N wafers emit impulse waves for m times successively, and the impulse waves reflected by the workpiece to be detected are completely received;

step 5, the process of the step 1 to the step 4 is repeated until defect detection is finished; and

step 6, a host 1 analytically processes the received impulse waves to obtain a defect graph of the workpiece to be detected, and the defect graph is displayed through a display, not illustrated in FIG. 1, of the host 1.

As a preferred mode of the present invention, the step 2 further comprises the following steps:

a first step, a timer 8 presets a fixed time interval, and the timer is connected with the chip 2;

a second step, the chip 2 controls a first switch 5 connected with an impulse wave emitting circuit, such that the impulse wave emitting circuit 3 is connected with a first wafer 9, and the first wafer 9 emits the impulse wave to the workpiece to be detected for the first time;

a third step, after the time interval elapses, the timer 8 sends a time signal to the chip 2;

a fourth step, after the time signal is received, the chip 2 controls the first wafer 9 to emit the impulse wave to the workpiece to be detected for the second time; the first wafer 9 does not finish work until the first wafer 9 emits the impulse wave to the workpiece to be detected for the m^{th} time, and at this moment, the count of the counter 7 connected with the chip 2 is 1;

a fifth step, after the time interval elapses, the timer 8 sends a time signal to the chip 2;

a sixth step, after the time signal is received, the chip 2 controls the impulse wave emitting circuit 3 to be connected with a second wafer, and the second wafer emits the impulse wave to the workpiece to be detected for the first time; and the working process of the third step and the fourth step is repeated until the count of the counter 7 is 2; and

a seventh step, the chip 2 controls a third wafer to a wafer N to repeat the working process of the fifth step and the sixth step until the count of the counter 7 is N.

The step 3 further comprises the following steps:

a first step, the chip 7 controls an impulse wave receiving circuit 4 to be connected with the first wafer 9 by controlling a second switch 6 connected with the impulse wave receiving circuit 4, and the first wafer 9 receives the impulse waves reflected by the workpiece to be detected;

a second step, after the first wafer 9 finishes receiving, the chip 2 controls the second switch 6 connected with the impulse wave receiving circuit 4 such that a wafer b10 is connected with the impulse wave receiving circuit 4, and the wafer b10 receives the impulse waves reflected by the workpiece to be detected, wherein the wafer b10 is a wafer transversely adjacent to the first wafer 9;

a third step, after the wafer b10 finishes receiving, the chip 2 controls the second switch 6 connected with the impulse wave receiving circuit 4 such that a wafer c11 is connected with the impulse wave receiving circuit 4, and the wafer c11 receives the impulse waves reflected by the workpiece to be detected, wherein the wafer c11 is a wafer longitudinally adjacent to the first wafer 9;

a fourth step, after the wafer c11 finishes receiving, the chip 2 controls the second switch 6 connected with the impulse wave receiving circuit 11 such that a wafer d12 is connected with the impulse wave receiving circuit 4, and the wafer d12 receives the impulse waves reflected by the workpiece to be detected, wherein the wafer d12 is a wafer slantwise adjacent to the first wafer 9; and

a fifth step, after the first wafer 9 finishes work, the second wafer repeats the process of the first step to the fourth step until the wafer N completes the process of the first step to the fourth step successively.

The chip is a programmable chip.

The N wafers refer to 52 wafers.

m in the step 2 is equal to 4.

### EMBODIMENT

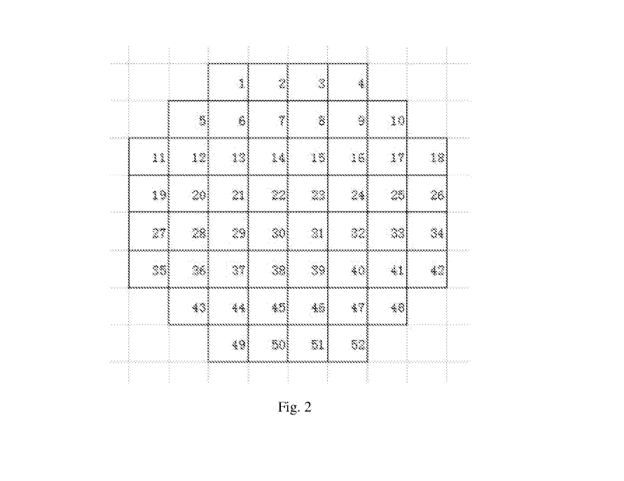

As shown in FIG. 2, 52 wafers are arranged in the form of an area array on an ultrasonic area array probe having a diameter of 10 mm; a timer 8 connected with a chip 2 presets a fixed time interval; the chip 2 controls a first switch 5 connected with an impulse wave emitting circuit, such that the impulse wave emitting circuit 3 is connected with a first wafer 9, and the first wafer 9 emits an impulse wave to a workpiece to be detected for the first time; meanwhile, a chip 7 controls an impulse wave receiving circuit 4 to be connected with the first wafer 9 by controlling a second switch 6 connected with the impulse wave receiving circuit 4, and the first wafer 9 receives the impulse wave reflected by the workpiece to be detected; after the time interval elapses, the timer 8 sents a time signal to the chip 2; after the time signal is received, the chip 2 controls the first wafer 9 to emit the impulse wave to the workpiece to be detected for the second time, and meanwhile, the chip 7 controls the impulse wave receiving circuit 4 to be connected with a second wafer by controlling the second switch 6 connected with the impulse wave receiving circuit 4, and the second wafer receives the impulse wave reflected by the workpiece to be detected; after the time interval elapses, the timer 8 sents a time signal to the chip 2; after the time signal is received, the chip 2 controls the first wafer 9 to emit the impulse wave to the workpiece to be detected for the third time, and meanwhile, the chip 7 controls the impulse wave receiving circuit 4 to be connected with a sixth wafer by controlling the second switch 6 connected with the impulse wave receiving circuit 4, and the sixth wafer receives the impulse wave reflected by the workpiece to be detected; after the time interval elapses, the timer 8 sents a time signal to the chip 2; after the time signal is received, the chip 2 controls the first wafer 9 to emit the impulse wave to the workpiece to be detected for the fourth time, and meanwhile, the chip 7 controls the impulse wave receiving circuit 4 to be connected with a fifth wafer by controlling the second switch 6 connected with the impulse wave receiving circuit 4, and the fifth wafer receives the impulse wave reflected by the workpiece to be detected; at this moment, the count of a counter 7 is 1.

After the time interval elapses, the timer 8 sents a time signal to the chip 2; after the time signal is received, the chip 2 controls the first switch 5 connected with the impulse wave emitting circuit, such that the impulse wave emitting circuit 3 is connected with the second wafer, and the second wafer emits the impulse wave to the workpiece to be detected for the first time; meanwhile, the chip 7 controls the impulse wave receiving circuit 4 to be connected with the second wafer by controlling the second switch 6 connected with the impulse wave receiving circuit 4, and the second wafer receives the impulse wave reflected by the workpiece to be detected; after the time interval elapses, the timer 8 sents a time signal to the chip 2; after the time signal is received, the chip 2 controls the second wafer to emit the impulse wave to the workpiece to be detected for the second time, and meanwhile, the chip 7 controls the impulse wave receiving circuit 4 to be connected with a third wafer by controlling the second switch 6 connected with the impulse wave receiving circuit 4, and the third wafer receives the impulse wave reflected by the workpiece to be detected; after the time interval elapses, the timer 8 sents a time signal to the chip 2; after the time signal is received, the chip 2 controls the second wafer to emit the impulse wave to the workpiece to be detected for the third time, and meanwhile, the chip 7 controls the impulse wave receiving circuit 4 to be connected with a seventh wafer by controlling the second switch 6 connected with the impulse wave receiving circuit 4, and the seventh wafer receives the impulse wave reflected by the workpiece to be detected; after the time interval elapses, the timer 8 sents a time signal to the chip 2; after the time signal is received, the chip 2 controls the second wafer to emit the impulse wave to the workpiece to be detected for the fourth time, and meanwhile, the chip 7 controls the impulse wave receiving circuit 4 to be connected with the sixth wafer by controlling the second switch 6 connected with the impulse wave receiving circuit 4, and the sixth wafer receives the impulse wave reflected by the workpiece to be detected; at this moment, the count of the counter 7 is 2.

The other wafers successively repeat the above process, and when the count of the counter 7 is 52, the chip 2 controls the first wafer to the 52^{nd} wafer to repeat the above process again until the detection of a defect detector is finished; in the above mode of emitting and receiving the impulse waves by the wafers, a host 1 processes and analyzes the impulse waves received by the 52 wafers, and a defect shape of the workpiece to be detected is displayed by a display of the host 1.

Each wafer in the present invention emits the impulse waves for 4 times, and the impulse waves are received by the wafer itself, transversely adjacent wafers, longitudinally adjacent wafers and the slantwise adjacent wafers, respectively; as compared with the case that a wafer independently emits and receives the impulse waves in the prior art, adopted waveform data is increased by 3 times; between every two adjacent wafers for sampling, a mode of one for emitting and the other one for receiving is adopted to realize a quadruple interpolated resolution, and therefore, a sampling resolution of a defect detector is improved; as a result, a resolution of a defect detector employing the detection method of the present invention is 4 times that in the prior art and a defect detection result is clearer and more accurate.

The defect detector of the present invention involves improvements based on existing equipment, and is simple in structure, low in cost and easy to popularize.

The counter is added in the present invention; the probe of the defect detector is provided with N wafers; when the defect detector works, 1 is added to the count of the counter after each wafer emits the impulse waves for m times; when the count of the counter is N, the chip controls the defect detector to start emitting the impulse waves again from the first wafer; and through repeatedly emitting and receiving the impulse waves, the defect shape of the workpiece to be detected obtained by the defect detector is more accurate.

The timer is added in the present invention, and the chip controls the time interval of emitting the impulse waves according to the time interval predetermined by the timer.

The foregoing descriptions are merely the preferred embodiments of the present invention rather than limiting the present invention; any modification, equivalent substitution, improvement and the like within the spirit and principle of the present invention should be included in the protection scope of the present invention.

1. A detection method capable of improving a resolution of an area array probe, comprising the following steps: step 1, an ultrasonic area array probe is provided with N wafers that are arranged in the form of an area array, wherein N represents the number of the wafers;
step 2, a chip controls a wafer a to emit impulse waves to a workpiece to be detected for m times, wherein a represents the ath wafer and m represents the times of emitting impulses;
step 3, the impulse waves reflected by the workpiece to be detected are successively received by the wafer a and (m−1) wafers adjacent to the wafer a, respectively;
step 4, all the N wafers emit impulse waves for m times successively, and the impulse waves reflected by the workpiece to be detected are received;
step 5, the process of the step 1 to the step 4 is repeated until defect detection is finished; and
step 6, a host analytically processes the received impulse waves to obtain a defect graph of the workpiece to be detected, and the defect graph is displayed through a display of the host.

2. The detection method capable of improving the resolution of the area array probe of claim 1, wherein the step 2 further comprises the following steps:
a first step, a timer presets a fixed time interval, and the timer is connected with the chip;
a second step, the chip controls a first switch connected with an impulse wave emitting circuit, such that the impulse wave emitting circuit is connected with a first wafer, and the first wafer emits the impulse wave to the workpiece to be detected for the first time;
a third step, after the time interval elapses, the timer sends a time signal to the chip;
a fourth step, after the time signal is received, the chip controls the first wafer to emit the impulse wave to the workpiece to be detected for the second time, and the first wafer does not finish work until the first wafer emits the impulse wave to the workpiece to be detected for the mth time, and at this moment, the count of the counter connected with the chip is 1;
a fifth step, after the time interval elapses, the timer sends a time signal to the chip;
a sixth step, after the time signal is received, the chip controls the impulse wave emitting circuit to be connected with a second wafer, and the second wafer emits the impulse wave to the workpiece to be detected for the first time; and the working process of the third step and the fourth step is repeated until the count of the counter is 2; and
a seventh step, the chip controls a third wafer to a wafer N to repeat the working process of the fifth step and the sixth step until the count of the counter is N.

3. The detection method capable of improving the resolution of the area array probe of claim 2, wherein the step 3 further comprises the following steps:
a first step, the chip controls a second switch connected with an impulse wave receiving circuit such that the impulse wave receiving circuit is connected with the first wafer, and the first wafer receives the impulse waves reflected by the workpiece to be detected;
a second step, after the first wafer finishes receiving, the chip controls the second switch connected with the impulse wave receiving circuit such that a wafer b is connected with the impulse wave receiving circuit, and the wafer b receives the impulse waves reflected by the workpiece to be detected, wherein the wafer b represents a wafer transversely adjacent to the first wafer;
a third step, after the wafer b finishes receiving, the chip controls the second switch connected with the impulse wave receiving circuit such that a wafer c is connected with the impulse wave receiving circuit, and the wafer c receives the impulse waves reflected by the workpiece to be detected, wherein the wafer c represents a wafer longitudinally adjacent to the first wafer;
a fourth step, after the wafer c finishes receiving, the chip controls the second switch connected with the impulse wave receiving circuit such that a wafer d is connected with the impulse wave receiving circuit, and the wafer d receives the impulse waves reflected by the workpiece to be detected, wherein the wafer d represents a wafer slantwise adjacent to the first wafer; and
a fifth step, after the first wafer finishes work, the second wafer repeats the process of the first step to the fourth step till the wafer N completes the process of the first step to the fourth step successively.

4. The detection method capable of improving the resolution of the area array probe of claim 1, wherein the chip is a programmable chip.

5. The detection method capable of improving the resolution of the area array probe of any one of claims 1-5, wherein the N wafers refer to 52 wafers.

6. The detection method capable of improving the resolution of the area array probe of claim 1, wherein m in the step 2 is equal to 4.
